(19) United States
(12) Patent Application Publication
(10) Pub. No.: US 2007/0138075 A1
(43) Pub. Date: Jun. 21, 2007

(54) External hanging type aquarium filtering device

(75) Inventor: Yung-Sheng Chang, Taipei Hsien (TW)

Correspondence Address: LEONG C LEI, PMB # 1008, 1867 YGNACIO VALLEY ROAD, WALNUT CREEK, CA, 94598, US

(73) Assignee: HI-Q TECHNOLOGY & MARKETING INC.

(21) Appl. No.: 11/305,235

(22) Filed: Dec. 19, 2005

(51) Int. Cl. A01K 63/04

(52) U.S. Cl. 210/167.22; 119/260

(57) ABSTRACT

An aquarium filtering device includes a body defining an interior divided into a water in-flow chamber and a filter chamber, and a barrier board and two filter panels disposed in the filter chamber. The filter panels have a vertical dimension smaller than the barrier board. The lower edge of the barrier board is spaced from the bottom of the filter chamber by projections formed on the bottom of the filter chamber thereby defining passages into a bio-decomposition section in which bio-filter balls are disposed. Water flowing through the filter panels or alternatively water overflowing the filter panels in case the filter panels are blocked by contaminants, is blocked by the barrier board and guided by the passages into the bio-decomposition section. Tabs are formed on the barrier board to prevent the bio-filter balls from entraining the water flow.

### BACKGROUND OF THE INVENTION

(a) Technical Field of the Invention

The present invention generally relates to an aquarium filtering device that is positioned outside the aquarium and hang on a wall of the aquarium, and in particular to an external hanging type aquarium filtering device having excellent performance in cleaning water of the aquarium.

(b) Description of the Prior Art

With the development of human society, people are earning more incomes, which allows most people to raise pets, including marine animals and plants. An aquarium tank is commonly employed to keep the marine animals and plants. The aquarium can also be considered parts of internal decoration of houses.

Due to the limited space inside the aquarium tank, fish food or droppings of the marine animals cause contamination to the water inside the tank. The contamination, which often causes diseases of the marine animals kept inside the aquarium, must be timely and properly removed. Besides frequent change of the water inside the aquarium, filtering devices can also be used to clean the water.

FIG. 1 of the attached drawings shows a conventional aquarium filtering device, which, in use, is hung outside a wall of an aquarium. As shown, he aquarium filtering device, which is designated with reference numeral 1, comprises a container body 1 defining an interior space which is divided by a partition 111 into a water in-flow chamber 112 and a filter chamber 113. A water conduit 13, which is of an angled shape, has opposite ends extending into the water in-flow chamber 112 and projecting outside the container body 11 and deeply extending into water contained in an aquarium (not shown) to which the filtering device is to attach.

Guide rails 114 are formed in the filter chamber 113 for receiving edges of a filter panel 12 and thus fixing the filter panel 12 inside the filter chamber 113. The container body 11 forms a water discharge opening 15 in communication with the filter chamber 113.

The filter panel 12 comprises a grid member defining a plurality of cells (not labeled) inside which active carbon particles 122 are kept and thin sheets of filtering sponges 121 are attached to opposite sides of the grid member to maintain the active carbon particles 122 in the grid member.

The end of the conduit 13 that extends into aquarium water forms an inlet opening (not shown) for the aquarium water. The inlet opening is provided with by a debris screening device 131, which serves to prevent debris or contaminants of large size to flow into the filtering device 1. Aquarium water is sucked into the water in-flow chamber 112 through the conduit 13 by the operation of a pump 14, which is located below the water in-flow chamber 112. A flow regulation knob 132 is provided on the conduit 13 to control/regulate the flow rate of water through the conduit 13.

Also referring to FIG. 2, although effective in cleaning up aquarium water, the conventional filtering device 1 suffers the drawback that the filtering sponge sheets 121 are often blocked by contaminants entraining the water flow through the filter panel 12, which causes overflow of the water over the filter panel 12 and thus deteriorating the performance of the filtering device 1. Besides, water that located on the lower portion of the filter chamber 113 stagnates, due to the blockage of the filter panel 12, and thus contaminants are at least partly kept inside the chamber 113 by the stagnation of water. Odor smells are thus caused by decomposition of the residual food or droppings that constitute in part the contaminants of the aquarium.

Thus, the present invention is aimed to effectively and completely clean aquarium water and eliminate odor smells caused by decomposition of residual contaminants.

### SUMMARY OF THE INVENTION

The primary purpose of the present invention is to provide an aquarium filtering device comprising a body, filter panels, a barrier board, a conduit, a pump, and a plurality of bio-filter balls. The body defines an interior space partitioned into a water in-flow chamber and a filter chamber. The filter panels and the barrier board are arranged in the filter chamber and supported on projections on the bottom of the filter chamber whereby a lower edge of the barrier board is spaced from the bottom of the filter chamber to define water passages therebetween. The barrier board delimits a bio-decomposition section in which the bio-filter balls are received. Water flows through the filter panels is blocked by the barrier board to pass through the passages into the bio-decomposition section to contact the bio-filter balls for bio-decomposition.

Another object of the present invention is to provide an aquarium filtering device wherein the filter panels have a height that is smaller than that of the barrier board whereby when the filter panels are blocked by contaminants, water overflows the upper edges of the filter panels to be guided by the passages below the barrier board into the bio-decomposition section to have entrained contaminants decomposed by the bio-filter balls. The barrier board forms projecting tabs that help retaining the bio-filter balls in position inside the bio-decomposition section.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional aquarium filtering device with a filter panel detached from a container body of the filtering device;

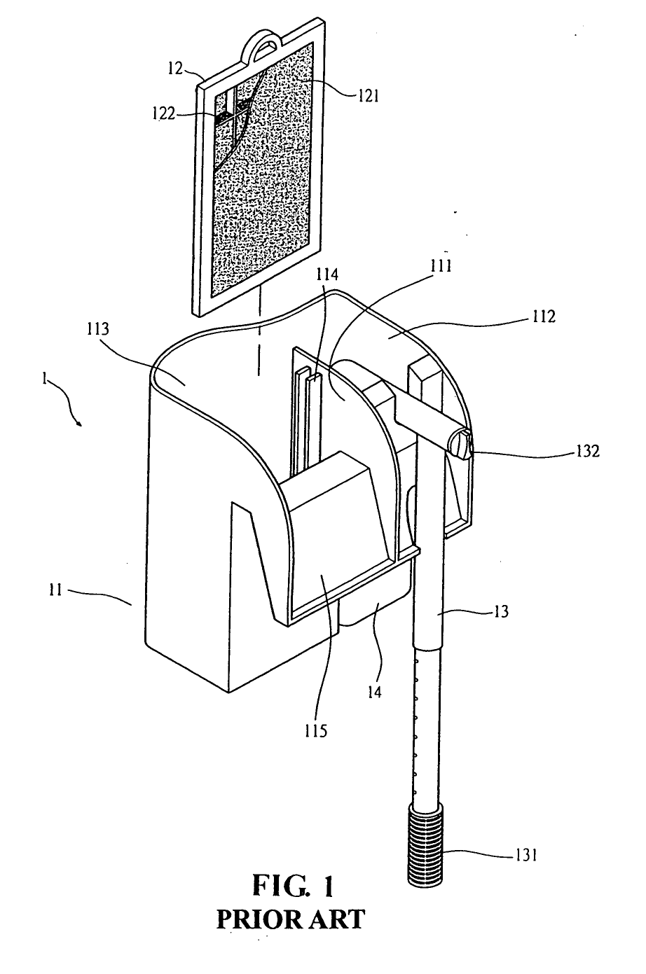

FIG. 2 is an assembled view of the conventional filtering device shown in FIG. 1;

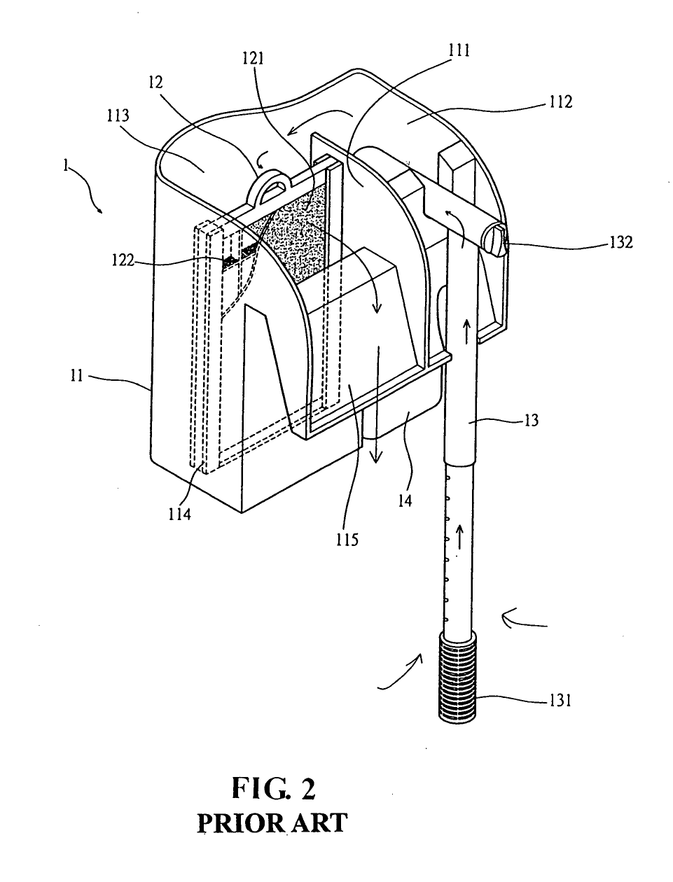

FIG. 3 is an exploded view of an aquarium filtering device constructed in accordance with the present invention;

FIG. 4 is a perspective view, taken from a top side, of the aquarium filtering device of the present invention; and

FIG. 5 is a cross-sectional view of the aquarium filtering device of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

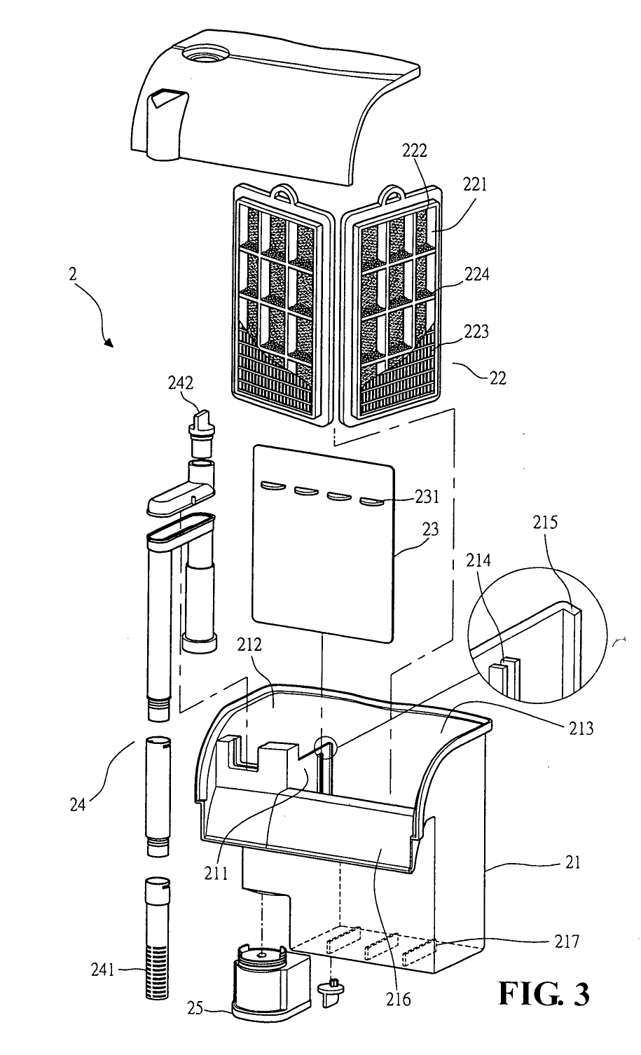

With reference to the drawings and in particular to FIG. 3, an aquarium filtering device constructed in accordance with the present invention, generally designated with reference numeral 2, comprises a container body 21, two filter panels 22, a barrier board 23, a conduit 24, a pump 25, and a plurality of bio-filter balls 3.

The container body 21 defines an interior space that is divided by a partition 211 into a water in-flow chamber 212 and a filter chamber 213. The conduit 24 is received in the in-flow chamber 212. The filter chamber 213 forms guide rail pairs 214 on opposite side walls (not labeled). Also formed on the opposite side walls of the filter chamber 213 are pawls 215 that are spaced from the guide rails 214. Each guide rail pair 214 forms a slot (not labeled) receivingly engageable with an edge of the barrier board 23 to secure the barrier board 23 inside the filter chamber 213. Each pawl 215 engages an edge of the respective filter panel 22. An opposite edge of the filter panel 22 is received in and retained by a retention rib 232 formed on the barrier board 23 to be secured inside the filter chamber 213. The container body 21 forms a water discharge opening 216 in communication with the filter chamber 213. A plurality of projections 217 is formed on a bottom of the filter chamber 213 to support the barrier board 23.

Each filter panel 22 comprises a board defining therein cavities or cells 221 that receive and accommodates active carbon particles 224. A sponge sheet 222 is attached to one surface of the board of the filter panel 22 to cover the cells 221 and to allow water flow into the cells 221 to contact the active carbon particles 224. A perforated cover having perforations 223 is mounted to an opposite surface of the board of the filter panel 22. Thus, water is allowed to flow through the filter panel 22. The filter panel 22 has a vertical dimension, namely height, smaller than the barrier board 23. In other words, in operation, an upper edge of the filter panel 22 is at a position below a corresponding upper edge of the barrier board 23.

The barrier board 23 has a thin board having opposite surfaces, with the retention rib 232 formed on one of the surfaces. A plurality of tabs 231, which in the embodiment illustrated, is of semi-circular shape, but can be of any desired shape, projects from an opposite surface of the barrier board 23. The retention ribs 232 forms slots (not labeled) on opposite sides thereof for respectively receiving edges of the filter panels 22. The barrier board 23, received and retained in the filter chamber 213, delimits, with a wall of the filter chamber 213, a bio-decomposition section 218 in which the bio-filter balls 3 are disposed.

The conduit 24 that is received in the in-flow chamber 212 is angle-shaped and has a distal end extending into water inside an aquarium to which the filtering device 2 is attached to serve as an inlet opening for water. The distal end forms a debris-screening filter 241 for filtering out debris and contaminants of large sizes. A flow regulation knob 242 is mounted on the conduit 24 to control flow rate of water through the conduit 24 and thus controlling the rate of removing contaminants from the aquarium.

The pump 25 is arranged below the in-flow chamber 212 of the container body 21 and serves to draw water from the aquarium through the conduit 24 into the in-flow chamber 212 for subsequent filtering operation.

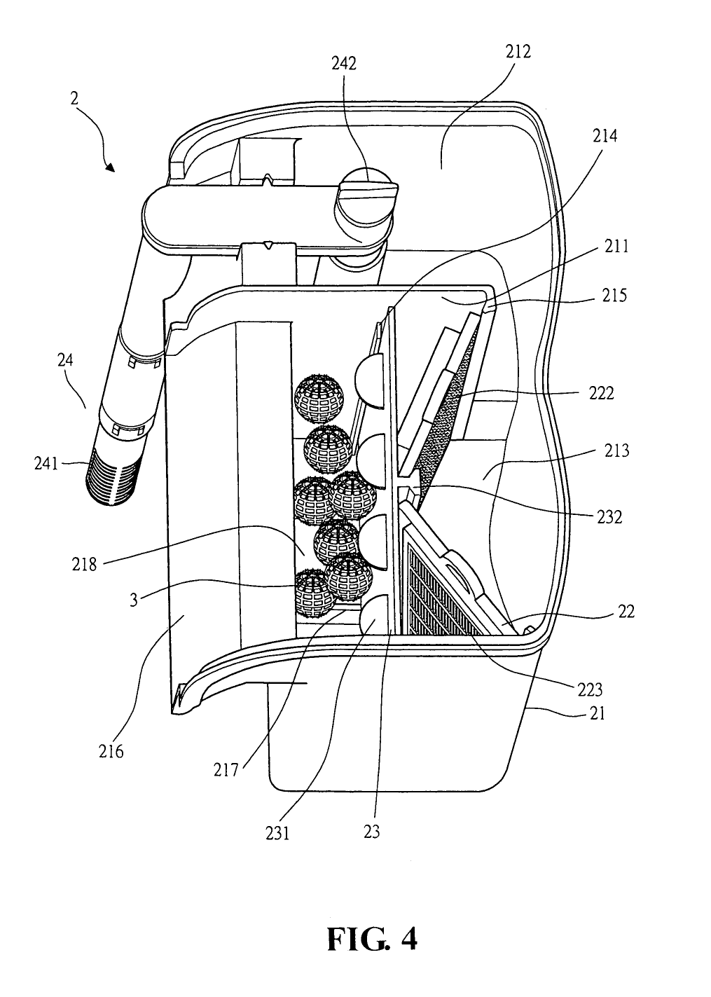

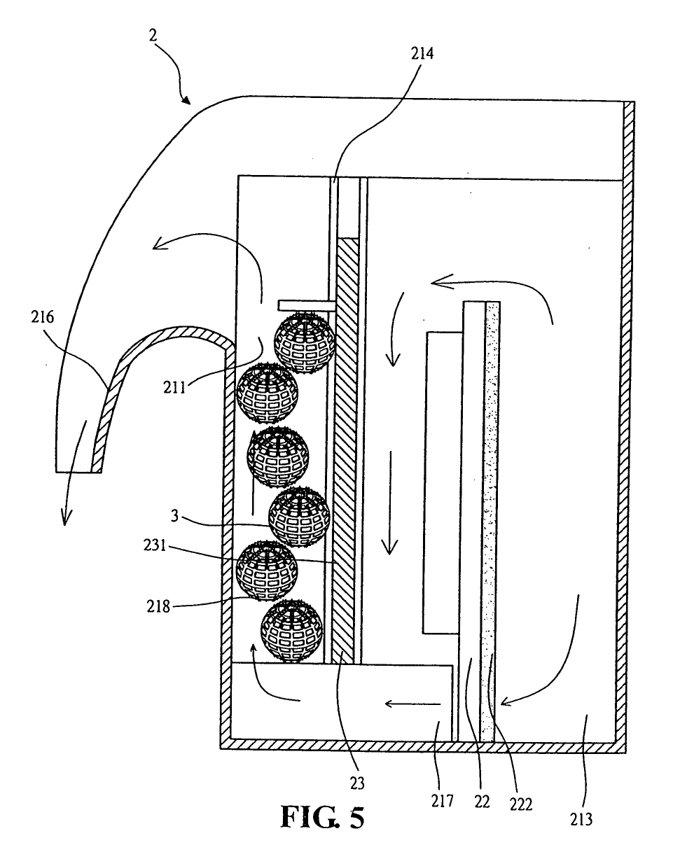

Also referring to FIGS. 4 and 5, in operation, a proximal end of the conduit 24 is positioned in the in-flow chamber 212 and is operatively coupled to the pump 25. The barrier board 23 is mounted in the filter chamber 213 with the edges thereof received in and retained by the guide rails 214 in such a manner that the barrier board 23 is positioned on the projections 217 that are formed on the bottom of the filter chamber 213 to form passages between a lower edge of the barrier board 23 and the bottom of the filter chamber 213. The disposition of the barrier board 23 into the filter chamber 213 also forms the bio-decomposition section 218. The bio-filter balls 3 are then positioned in the bio-decomposition section 218.

The filter panels 22 are then put in the filter chamber 213 with opposite edges of each filter panel 22 engaging and retained by the pawl 215 and the retention rib 232 of the barrier board 23.

By powering the pump 25, water inside the aquarium is sucked through the debris-screening filter 241 into the conduit 24, and is then guided to the in-flow chamber 212 and then to the filter chamber 213 in which the water is guided through the filter panels 22. The water that is filtered and thus cleaned by the filter panels 22 is blocked by the barrier board 23 and is only allowed to flow through the passages formed between the lower edge of the barrier board 23 and the bottom of the filter chamber 213 formed by the projections 217. The water is thus guided into the bio-decomposition section 218 and thus subject to bio-processing or bio-decomposition by the bio-filter balls 3. The tabs 231 of the barrier board 23 serves to retain the bio-filter balls 3 in position against the water flow.

By means of the projections 217 formed on the bottom of the filter chamber 213, a spacing is defined between the lower edge of the barrier board 23 and the bottom of the filter chamber 213, which guides the water flow into the bio-decomposition section 218, while the water is blocked by the barrier board 23. In addition, the filter panels 22 have a height smaller than that of the barrier board 23, which helps overflow of water over the filter panels 22 into spaces between the filter panels 22 and the barrier board 23 and then flowing through the passages below the barrier board 23. The water is further subject to bio-decomposition by the bio-filter balls 3 within the bio-decomposition section 218, which serves to clean the water in case the filter panels 22 are blocked by contaminants.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An aquarium filtering device comprising a container body, at least one filter panel, a conduit, a pump, and at least one bio-filter ball, the container body defining an interior space that is divided by a partition into a water in-flow chamber and a filter chamber, at least one projection formed on a bottom of the filter chamber, a barrier board being received in the filter chamber and spaced from the bottom of the filter chamber by the projection whereby a water passage is formed between a lower edge of the barrier board and the bottom of the filter chamber, the barrier board delimiting a bio-decomposition section in which the bio-filter ball is received, wherein water flows through the water passage into the bio-decomposition section and subject to bio-decomposition by the bio-filter ball.

2. The aquarium filtering device as claimed in claim 1, wherein the filter panel has a height smaller than the barrier board.

3. The aquarium filtering device as claimed in claim 1, wherein barrier board forms at least one tab that retains the bio-filter ball in position inside the bio-decomposition section.

4. The aquarium filtering device as claimed in claim 1, wherein the barrier board forms a retention rib to engage and retain the filter panel in position.
